(19) United States
(12) Patent Application Publication
(10) Pub. No.: US 2018/0015313 A1
(43) Pub. Date: Jan. 18, 2018

(54) PERSONNEL PROTECTION APPARATUS

(71) Applicant: Christopher PROBERT, Denmark (AU)

(72) Inventor: Christopher PROBERT, Denmark (AU)

(21) Appl. No.: 15/548,231

(22) PCT Filed: Feb. 3, 2016
(86) PCT No.: PCT/AU2016/000021

§ 371 Date: Aug. 2, 2017

(30) Foreign Application Priority Data
Feb. 3, 2015 (AU) 2015900317

(51) Int. Cl. A62C 2/06; E04H 15/54; E04H 15/04; A62C 3/02; A62C 27/00

(52) U.S. Cl. CPC A62C 2/06; E04H 15/54; E04H 15/04; A62C 27/00; A62C 3/02

(57) ABSTRACT

A personnel protection apparatus (22) for protecting personnel involved in fighting a fire comprising a flexible multi-layer wall member (32) mounted at an elevated position on a fire fighting truck (10), the wall member (32) being arranged to be stored in contracted condition within the vehicle (10) when not required for use and being arranged to be deployed from the vehicle (10), externally thereof so as to provide a protective enclosure which extends from the vehicle (10) to ground level for personnel.

### FIELD OF INVENTION

The present invention relates to a personnel protection apparatus.

### BACKGROUND OF INVENTION

It is known that in fighting fires in bush or forest areas it is necessary for the personnel involved to be protected from risk when the fire is very intense and/or when there is significant ambient wind which may change direction without warning.

It is known to provide enclosures for the cabs or fire fighting vehicles which offer some protection in an emergency. However, the protection available is limited in the time that it affords protection to personnel in the cab. There is a need for an improved system which provides longer lasting and more effective protection to personnel confronted with a fire fighting emergency.

The present invention attempts to overcome, a least in part, disadvantages of previously known safety systems for protecting fire fighting personnel.

### SUMMARY OF THE INVENTION

In accordance with one aspect of the present invention is provided a personnel protection apparatus for use in fighting a fire which comprises a mechanism arranged to be mounted at an elevated position on a fire fighting vehicle, the mechanism comprising a housing containing a flexible multi-layer wall member, the wall member being arranged to be stored in the vehicle in a contracted condition and to be deployed when required for use to extend downwardly externally of the vehicle to provide a protective enclosure for personnel.

The wall member preferably is a multi-layer wall means in which layers of the wall means are spaced apart when deployed.

Further the wall member preferably forms a laterally endless wall when deployed.

Yet further, the apparatus may comprise a frame member contained initially in the housing and the flexible wall member is arranged to be stored in the vehicle in a contracted condition within the frame member.

Yet still further, the frame member is preferably arranged to be contained within the vehicle when not required for use and to be moved to a position external of the vehicle when required for use.

### BRIEF DESCRIPTION OF THE DRAWINGS

The present invention will now describe with reference to the accompanying drawings, in which

FIG. 1 is a side view of a fire fighting truck embodying the apparatus of the present invention;

FIG. 2 is a view similar to FIG. 1 showing a fire fighting safety apparatus of the present invention ready to be deployed for use;

FIG. 3 is a view similar to FIG. 2 showing a side elevation of the fire fighting apparatus in deployed condition;

FIG. 4 is a rear elevation of the fire fighting apparatus showing FIG. 3;

FIG. 5 is a side elevation of another embodiment of fire fighting truck which is of smaller construction than that of FIG. 1 but also embodies the apparatus of the present invention;

FIG. 5b is a view similar to FIG. 5 showing an alternative means of deploying the apparatus of the present invention;

FIG. 6 is a view similar to FIG. 3 showing the apparatus of the present invention in use in protecting personnel from a fire;

FIG. 7 is a schematic cross sectional elevation of part of a wall of the deployed apparatus shown in FIG. 6;

FIG. 8 is a schematic side elevation of the deployed apparatus of FIG. 6 showing the wall structure of the deployed apparatus; and

FIG. 9 shows spacer means for use in the apparatus of the present invention.

### DESCRIPTION OF PREFERRED EMBODIMENTS

In FIGS. 1 to 3 of the accompanying drawing there is shown a fire fighting truck 10 of known type comprising a chassis 12 mounted on a plurality of wheels 14. The chassis supports a front cab 16 for accommodation of a fire fighting crew. Also the chassis supports a plurality of water tanks 18.

At a rear end 19 of the truck 10 remote from the cab 16 there is provided an assembly 20 provided with a personnel protection apparatus 22 in accordance with the present invention.

As shown in FIG. 1, the apparatus 22 comprises a roof portion 23.

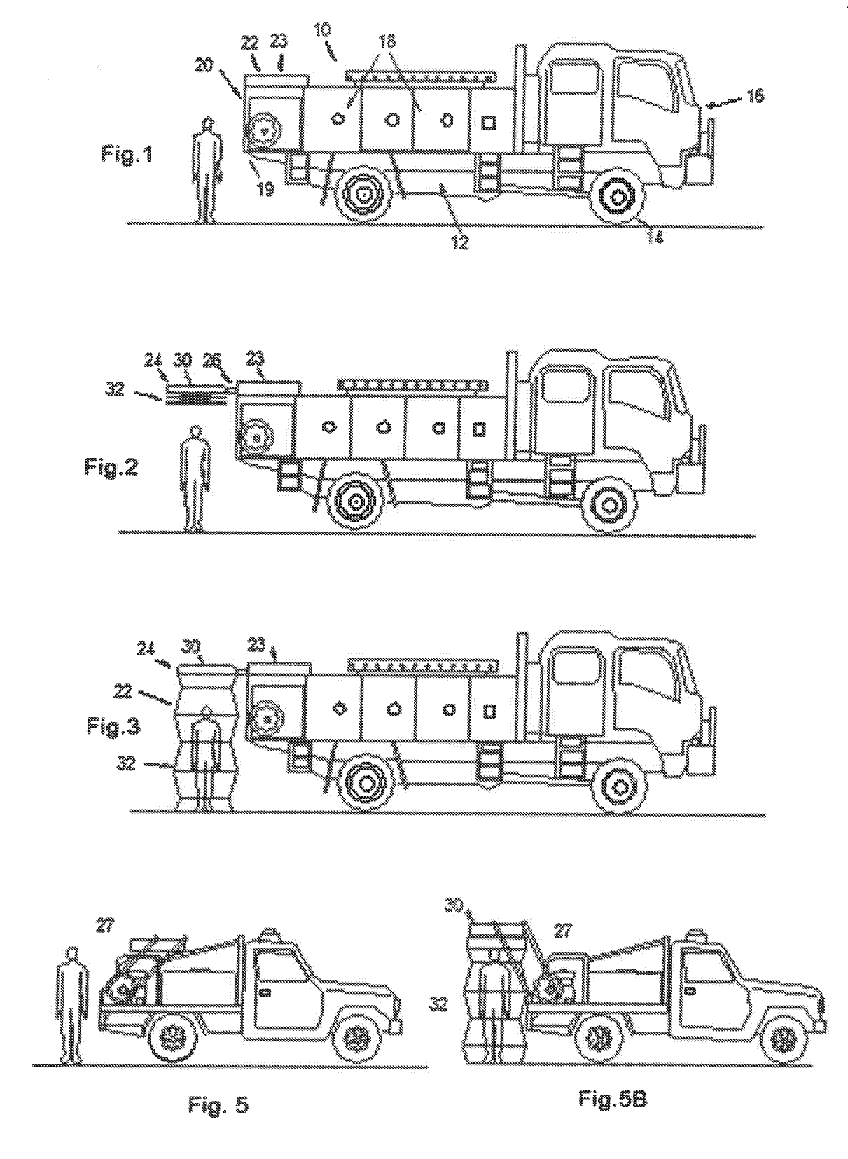

As shown in FIG. 2, the apparatus 22 is arranged to dispense a fire protection assembly 24 from the roof portion 23 by means of a reciprocable arm 26.

The arm 26 comprises an outer end connected to a frame member 30 having mounted therein a fire protective wall member 32. As shown in FIG. 2 the wall member 32 is disposed initially in contracted condition.

The roof portion 23 maybe formed of a plurality of layers of corrugated iron, such as three layers, with contiguous layers disposed at 90° to one another. This arrangement provides minimal areas of contact for conduction of heat between the layers. However, the roof portion 23 may have many configurations although a flame proof upper layer is preferred. In fact, has been found that the use of plurality of corrugated iron layers disposed at 90° to one another as discussed above is highly effective.

As shown in FIG. 2, in the event of a fire personnel may gather under the frame member 30. The wall member 32 may then be released so as to extend downwardly preferably under the influence of gravity, so as to form a protective enclosure isolating personnel under the frame member 30 by means of the extended wall member 32 as shown in FIG. 3.

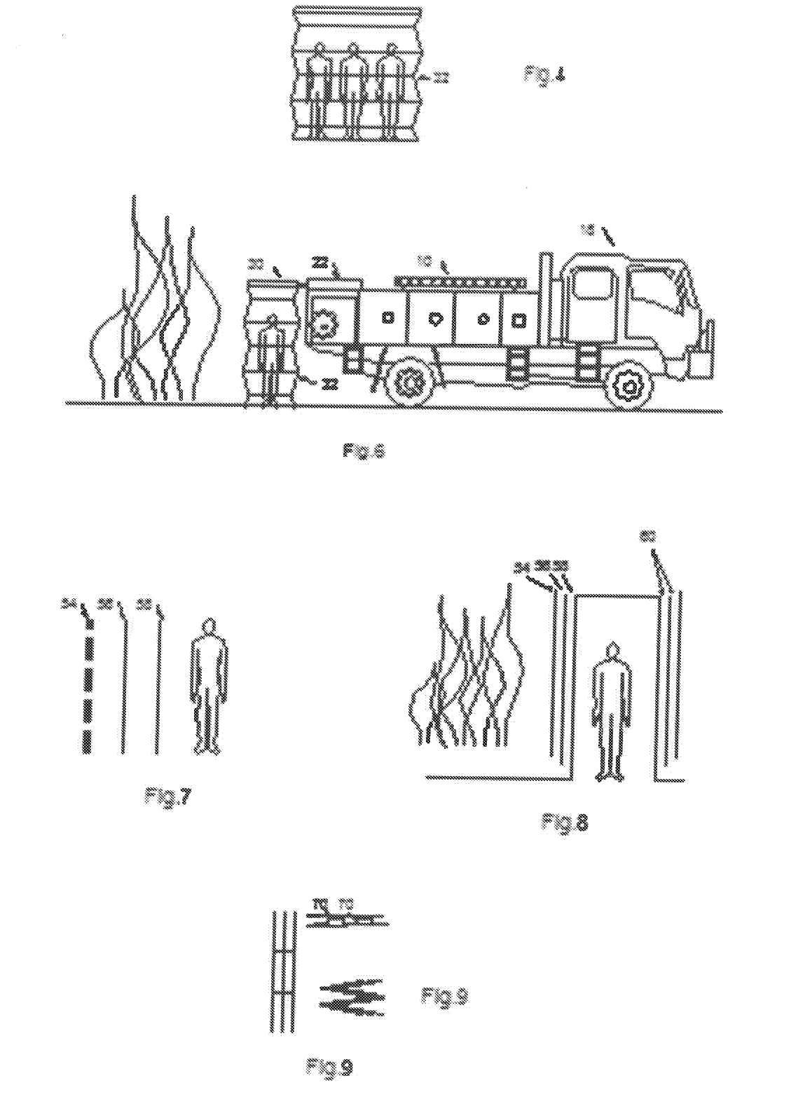

As shown in FIG. 4, the protective enclosure 34 may be sufficiently wide or deep to accommodate a plurality of personnel members. Preferably, means is provided for manually releasing the wall member 32 to the position shown in FIG. 3 and for returning the wall member 32 to the contracted position shown in FIG. 2. The manually control means may be in the form of ropes or cords. In an alternative arrangement shown in FIG. 5, the fire fighting apparatus 22 of the present invention may be utilized in relation to a smaller vehicle 40.

As shown in FIG. 6, the fire protection apparatus 22 may conveniently be disposed at the rear of the truck 10 with the wall member 32 extended downwardly and the truck 10 backed up to an adjacent source of heat 50.

As shown in FIG. 7, the wall member 32 is preferably provided with a plurality of layers. At first outer layer 54 may be formed of a highly heat resistant material. An intermediate layer 56 and an inner layer 58 are preferably formed of heat shield fabrics.

The outer layer 54 may be formed of a ceramic fibre such as silica. This may be in the form of outer mat, which may be produced by the following technique.

The outer wall ceramic fibre mat maybe made by drawing and spinning a ceramic fibre that is spun with cotton and fine stainless steel wire. The resulting composite thread is woven into a mat and the cotton burned off. The mat is then coated with a polymer to hold the material together. In the event of a fire, the polymer burns off but the stainless steel which is in the form of a mesh holds the woven ceramic material together. The key function of the outer layer 54 is to prevent naked flame contacting the inner layers 56 and 58. It must be physically robust to sustain prolonged exposure to flame.

The two inner layers 56 and 58 may be formed of a plastics material provided with a heat reflective layer on one side. The heat reflective layer may be formed of aluminium. A number of similar materials and common wool blanket material give similar results.

The material of the outer layer 54 needs to be able to withstand temperatures of 500° C.+ for over ten minutes without physical deterioration. The material of the inner layers 56 to 58 should be highly reflective on one side (the hot side). The layers 54, 56 and 58 need to be foldable for stowing within the frame member 30.

The gaps between the three layers 54, 56 and 58 are crucial and are a trade-off between heat rejection and compactness for transport and stowing. The gaps may be in the range of 20 to 100 mm wide, such as about 40 to 60 mm wide, preferably about 50 mm wide.

Spacing of the walls 54, 56 and 58 reduces heat transfer inwardly from the exterior. As shown in FIG. 8, it is preferred that the inner most layer 58 extends to ground level to form an inner chamber whilst the intermediate layer 56 is spaced a small amount from the ground whilst the outer layer 54 is spaced a slightly larger amount from the ground.

The spacing of the layers 54 and 56 from the ground enables intake of cool air to enter spaces 60 between the layers by convection which helps maintain the inner chamber at a moderate temperature even when the external temperature is at very high temperature such as 500° C. or more. The convected air flows upwardly and exits from the apparatus at the level of the frame 30. Further, the convection effect assists in keeping the chamber within the wall member 32 smoke free and fume free.

The spaces 60, between the layers 54, 56 and 58 may be maintained by using spacers 70 as shown in FIG. 9. The spacers 70 are preferably arranged to spring laterally outward when the wall member 32 is deployed but to fold inwardly when the wall member 32 is folded for stowage. The spacer 70 may be made of steel wire.

Modifications and variations such as would be apparent to a skilled addressee are deemed within the scope of the present invention. For example, it is envisaged in relation to the embodiments of FIGS. 5, and 5b, that the apparatus 22 could be provided with parallel pivotable arms. In order to deploy the wall member 32, the pivotable arms could be swung outwardly so that the wall member 32 may be deployed to the rear of the vehicle.

1-10. (canceled)

11. A personnel protection apparatus for protecting personnel involved with fighting a fire, characterized in that it comprises a mechanism arranged to be mounted at an elevated position on a fire fighting vehicle, the mechanism comprising a frame member containing a flexible wall member, the flexible wall member being arranged to be stored in the frame member in contracted condition and to be deployed when required for use to extend downwardly to provide a protective enclosure for personnel, wherein the apparatus further comprises reciprocally movable arm means connected to the frame member such that, when the apparatus is required for use, the arm means is moved to a position where the frame member is spaced away from the vehicle such that the wall member can be released downwardly from the frame member and deployed so as to form a protective enclosure for personnel spaced apart from the vehicle.

12. A personnel protection apparatus according to claim 11, characterized in that the wall member has a multi-layer wall in which layers of the wall are spaced apart when deployed.

13. A personnel protection apparatus according to claim 12, characterized in that the wall member forms a lateral endless wall when deployed.

14. A personnel protection apparatus according to claim 12 characterized in that the wall member is provided with a plurality of layers in which a first outer layer is formed of a highly heat and flame resistant ceramic material.

15. A personnel protection apparatus according to claim 14, characterized in that the wall member comprises at least one inner layer formed of heat resistant fabric with a heat reflective surface on at least one side thereof.

16. A personnel protection apparatus according to claim 15, characterized in that gaps between the layers of the wall member when deployed are in the range from 20 mm to 100 mm wide.

17. A personnel protection apparatus according to claim 16, characterized in that gaps between the layers of the wall member when deployed are in the range from 40 mm to 60 mm wide.

18. A personnel protection apparatus according to claim 17, characterized in that spreaders are provided between adjacent layers of the wall member when deployed for maintaining the desired gaps.

19. A personnel protection apparatus according to claim 11, characterized in that the wall member is arranged to be deployed under the influence of gravity.

20. A personnel protection apparatus according to claim 18, characterized in that, an innermost layer of the wall member extends to ground level whilst an intermediate layer is spaced a small amount from the ground whilst an outer layer is spaced a slightly larger amount from the ground so as to enable cool air to enter gaps between the layers by convection to assist in maintaining an inner chamber of the protective enclosure at moderate temperature.

21. A personnel protection apparatus according to claim 12, characterized in that, an innermost layer of the wall member extends to ground level whilst an intermediate layer is spaced a small amount from the ground whilst an outer layer is spaced a slightly larger amount from the ground so as to enable cool air to enter gaps between the layers by convection to assist in maintaining an inner chamber of the protective enclosure at moderate temperature.

22. A personnel protection apparatus according to claim 12, characterized in that gaps between the layers of the wall member when deployed are in the range from 20 mm to 100 mm wide.

23. A personnel protection apparatus according to claim 13, characterized in that gaps between the layers of the wall member when deployed are in the range from 20 mm to 100 mm wide.

24. A personnel protection apparatus according to claim 14, characterized in that gaps between the layers of the wall member when deployed are in the range from 20 mm to 100 mm wide.

25. A personnel protection apparatus according to claim 13, any one of the preceding characterized in the wall member is provided with a plurality of layers in which a first outer layer is formed of a highly heat and flame resistant ceramic material.

26. A personnel protection apparatus according to claim 16, characterized in that spreader means are provided between adjacent layers of the wall member when deployed for maintaining the desired gaps.
